(19) United States
(12) Patent Application Publication
(10) Pub. No.: US 2012/0005582 A1
(43) Pub. Date: Jan. 5, 2012

(54) PARENT PLAYBACK

(76) Inventors: Jo Webber, Philadelphia, PA (US); Pradeep Ittycheria, Philadelphia, PA (US)

(21) Appl. No.: 12/991,053

(22) PCT Filed: Sep. 3, 2010
(86) PCT No.: PCT/US2010/047785

§ 371 Date: Apr. 8, 2011

Related U.S. Application Data
(60) Provisional application No. 61/272,233, filed on Sep. 3, 2009.

(51) Int. Cl. G06F 15/16; G06F 3/01

(52) U.S. Cl. 715/736

(57) ABSTRACT

A persistent software system and method for allowing parents or persons responsible for children to record and playback a child's activities on a web based system. A playback software utility implemented as a web-service or as an embedded web-based system to record all user activities and support playback as if the user's activity was recorded in real-time. This invention consists of a set of recording and playback software scripts that can be executed via a web service or can reside on a service requesting web based system. The invention consists of a player that allows for the recorded activity to be played back either on the web based system that requested the service or a third party application.

### CROSS-REFERENCE TO RELATED APPLICATIONS

This application claims the priority and benefit of U.S. Provisional Patent Application No. 61/272,233, U.S. Provisional Patent Application No. 61/272,235, U.S. U.S. Provisional Patent Application No. 61/272,234, and U.S. Provisional Patent Application No. 61/272,232, all of which were filed on Sep. 3, 2009 and are incorporated herein by reference.

This application is related to U.S. patent application Ser. No. XX/XXX,XXX, identified by Attorney Docket No. 101035-5004-US, which claims the priority and benefit of U.S. Provisional Patent Application No. 61/272,235, which was filed on Sep. 3, 2009, and is incorporated herein by reference.

This application is related to U.S. patent application Ser. No. XX/XXX,XXX, identified by Attorney Docket No. 101035-5003-US, which claims the priority and benefit of U.S. Provisional Patent Application No. 61/272,232, which was filed on Sep. 3, 2009, and is incorporated herein by reference.

This application is related to U.S. patent application Ser. No. XX/XXX,XXX, identified by Attorney Docket No. 101035-5002-US, which claims the priority and benefit of U.S. Provisional Patent Application No. 61/272,234, which was filed on Sep. 3, 2009, and is incorporated herein by reference.

### BACKGROUND OF THE INVENTION

1. Field of the Invention

The present invention relates to providing parental recording/playback features, and more particularly, to providing parental features that allow parents to record and playback a child's activities on a web-based system.

2. Discussion of the Related Art

Generally, parental control systems fall under one of two categories. First, active control parental control systems prevent a child from accessing information that the parent does not want them to access. For example, active parental control systems include programs such as hardware and software firewalls as well as hardware access controls tools or systems that prevent certain types of data from being presented to a user. Second, passive control parental control systems allow parents to audit information that their children have been accessing and activities that their children engaged in while they are online, on a computer system, or on a managed or unmanaged network. For example, passive parental control systems include systems that audit user access and activity information in managed and unmanaged networks and present this information to parents. Passive methods provide logs of activities performed by the child. These logs typically are listings of applications run, data entered, etc.

### SUMMARY OF THE INVENTION

Accordingly, the present invention is directed to a recording/playback feature that substantially obviates one or more problems due to limitations and disadvantages of the related art.

An embodiment of the present invention provides a parent with a software system and method for allowing parents or persons responsible for children to record and playback a child's activities on a web-based system.

Another embodiment of the present invention provides parents or persons responsible for children with a more real feel of what their child has been doing while on a web-based system as compared to the passive auditing systems or methods available.

Another embodiment of the present invention provides a playback software utility implemented as a hosted web-service that may be called by a requestor or as an embedded web-based system to record all user activities and support playback as if the user's activity was recorded in real-time.

Of course, the present invention is not limited to use by parents and children, but encompasses use by any individual desiring to monitor computer activities.

The parent playback includes a player that allows for the recorded activity to be played back either as an embedded player in a web-based system or through a central location.

An embodiment of the present invention provides a computer-implemented method for monitoring, transmitting, and recording usage of a computer or mobile device connected to a network, comprising the steps of executing a script locally on the computer or mobile device, the script facilitating a connection to one or more servers accessible by the computer or mobile device over the network; monitoring the usage of the computer or mobile device as displayed on a display device; transmitting usage data to a storage device, the storage device residing on the one or more servers accessible by the computer or mobile device over the network; and recording, by the storage device, the usage data received from the script.

In some embodiments, the monitoring step further comprises invoking a print screen function.

In some embodiments, the print screen function is invoked at a specific time interval.

In some embodiments, the monitoring step further comprises saving temporarily the usage in local memory on the computer or mobile device.

In some embodiments, the transmitting step is performed continuously.

In some embodiments, the transmitting step is performed when the local memory available for saving temporarily is near a threshold capacity.

In some embodiments, the executing step is performed at a predetermined start time.

In some embodiments, the execution of the script is stopped at a predetermined stop time.

In some embodiments, the execution of the script is stopped after a predetermined time has passed.

In some embodiments, the usage data recorded on the storage device is accessed.

An embodiment of the present invention provides a computer-implemented method for playing recorded usage of a computer or mobile device, comprising the steps of connecting, by a playback computer or playback mobile device, to one or more servers accessible by the playback computer or playback mobile device over a network; requesting access to the recorded usage of the computer or mobile device, as displayed on a display device of the computer or mobile device; receiving access to usage data stored on a storage device, the storage device residing on the one or more servers accessible by the playback computer or playback mobile device over the network; and playing, by the playback computer or playback mobile device, the usage data stored on the storage device.

An embodiment of the present invention provides a computer-implemented method for playing recorded usage of a computer or mobile device without connecting to a network, comprising the steps of connecting directly, by a playback computer or playback mobile device, to a computer or mobile device; requesting access to the recorded usage of the computer or mobile device, as displayed on a display device of the computer or mobile device; receiving access to usage data stored locally on a storage device, the storage device residing on the computer or mobile device; and playing, by the playback computer or playback mobile device, the usage data stored on the computer or mobile device.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve advantages and in accordance with the purpose of the present invention, as embodied and broadly described, the parent playback includes a set of recording and playback software scripts that can be executed via a web service or can reside on a service requesting web-based system.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1 is an illustration of an exemplary embodiment in accordance with the present invention where usage data may be recorded client-side, transmitted to and stored on one or more servers, then accessed over a network;

FIG. 2 is an illustration of an exemplary embodiment in accordance with the present invention where usage data may be recorded client-side and accessed directly without the use of a network;

FIG. 3 is an illustration of an exemplary system block diagram of a computer or mobile device executing the parent recording/playback application in accordance with the present invention;

FIG. 4 is an illustration of an exemplary application modules diagram in accordance with the present invention;

FIG. 5 is an illustration of exemplary method steps for monitoring, transmitting, and recording usage of a computer or mobile device connected to a network;

FIG. 6 is an illustration of exemplary method steps for playing recorded usage of a computer or mobile device; and

FIG. 7 is an illustration of exemplary method steps for playing recorded usage of a computer or mobile device without connecting to a network.

### DETAILED DESCRIPTION

Reference will now be made in detail to embodiments, examples of which are illustrated in the accompanying drawings. In the following detailed description, numerous non-limiting specific details are set forth in order to assist in understanding the subject matter presented herein. It will be apparent, however, to one of ordinary skill in the art that various alternatives may be used without departing from the scope of the present invention and the subject matter may be practiced without these specific details. For example, it will be apparent to one of ordinary skill in the art that the subject matter presented herein can be implemented on any type of standalone system or client-server compatible system containing any type of client, network, server, and database elements. Wherever possible, like reference numbers will be used for like elements.

At the outset, certain terms will be described.

A web-based system is a web-based or Internet enabled desktop or mobile software application. A web-based system is a software system that communicates with a server or backend system over the Internet. A web-based application is accessed by its users over the Internet. An Internet enabled desktop or mobile application may need its users to access its functionality in a browser.

Web service (also webservice), as defined by the W3C, is a software system designed to support interoperable machine-to-machine interaction over a network.

An application programming interface (API) is an interface that defines the ways by which an application program may request services from libraries and/or operating systems.

Real-time in the context of this invention is as the user performs an action.

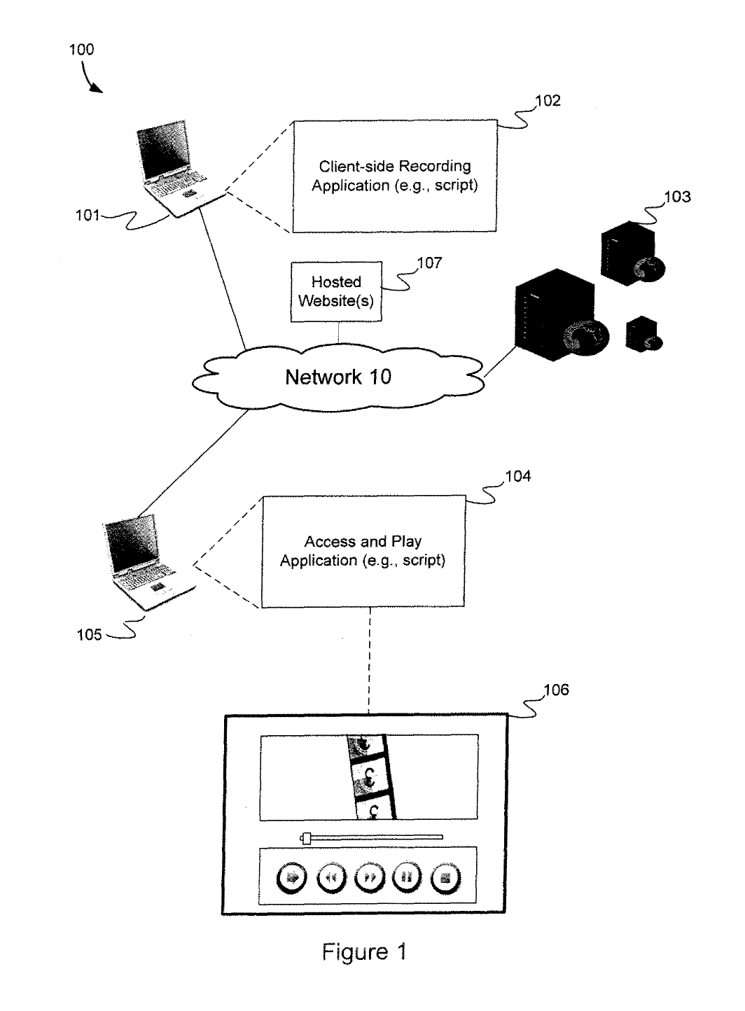

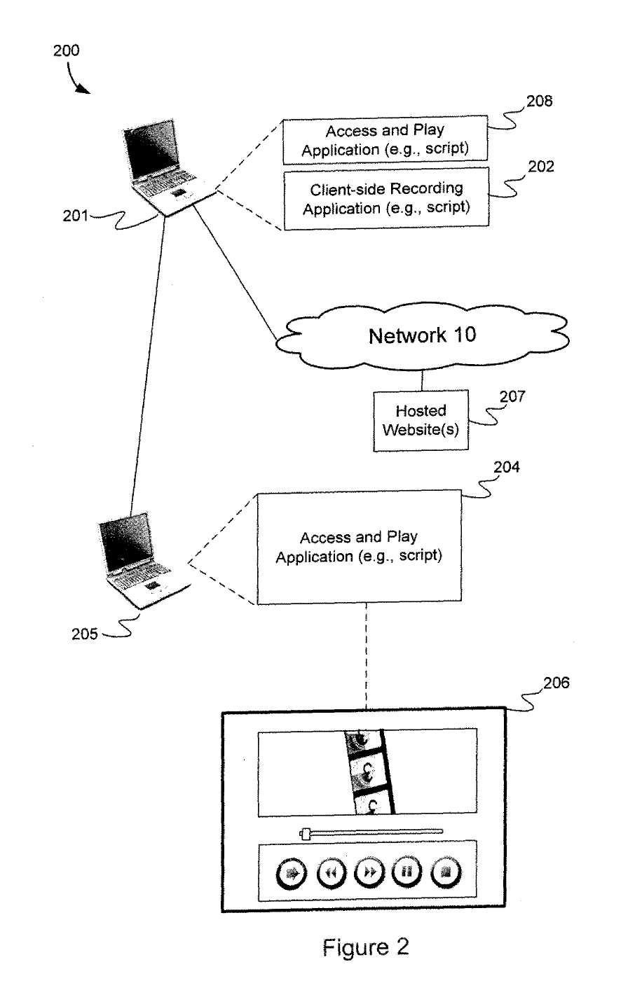

FIG. 1 is an illustration of an exemplary embodiment 100 in accordance with the present invention where usage data may be recorded client-side, transmitted to and stored on one or more servers, then accessed over a network. The exemplary system 100 comprises a computer 101, which may be connected to a network 10 (e.g., Wide Area Network (WAN), Metropolitan Area Network (MAN), or Local Area Network (LAN)) over a wired (e.g., TCP/IP over Ethernet, IEEE 802.3) or wireless (e.g., WiFi (802.11), GSM, GPRS, W-CDMA, EDGE, or the like) communications protocol/layer, for access to one or more hosted website(s) 107. A handheld device (not shown) with a processor and memory may also be used in lieu of the computer 101. The handheld device may be configured for communication over the network 10. The network 10 may be connected to one or more servers 103 with access to one or more media storage devices (e.g., storage servers, databases, or the like). The servers 103 may receive requests over the network 10 to store (via the client-side recording application 102), retrieve (via the access and play application 104), and transmit one or more files that may contain usage content (e.g., usage content of a user using computer 101, or the like). The client-side recording application 102 and access and play application 104 may be implemented as separate applications or as features of a single recording/playback application, without departing from the scope of the present invention (for ease of reference, the names of the applications may be used interchangeably herein and the use of one of the applications does not imply exclusion of any of the other applications). Alternatively, the computer 101 may store and load files locally in and from storage (e.g., hard drive, flash drive, CD-ROM/RW, tape drive, solid state memory, or the like) (as described for the exemplary embodiment 200 of FIG. 2), or via a connection to one or more other computers or servers 103 (e.g., remotely).

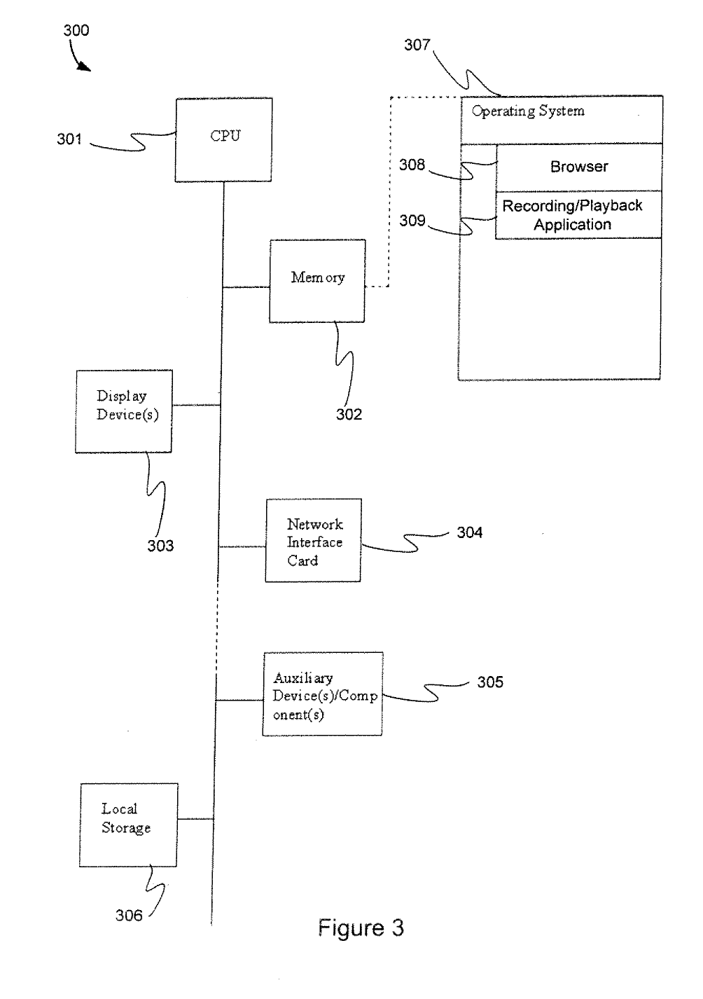

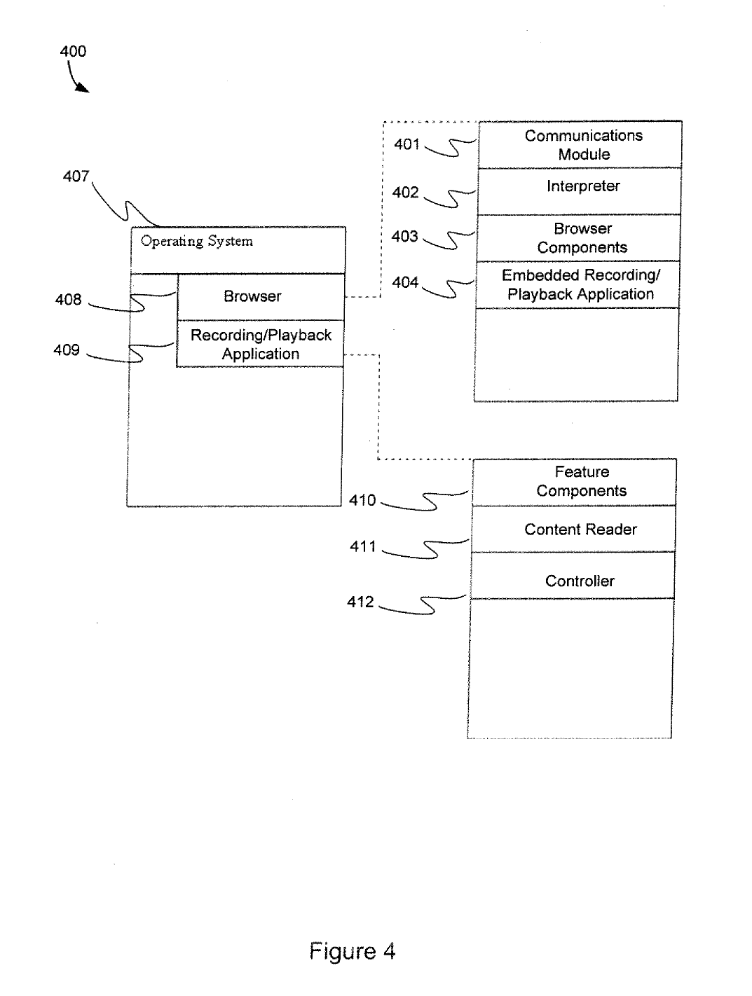

In some embodiments, the client-side recording application 102 (or, alternatively, recording/playback application) may be implemented by a recording/playback application module 409 (shown in FIG. 4) that executes on an operating system 407 (also shown in FIG. 4). The recording/playback application module 409 (or, a browser module 408 executing an embedded recording/playback application module 404) may call one or more modules via an application programming interface (API), or may implement the programming code (e.g., object-oriented event/exception-based code) necessary, for recording the usage data of a user of the computer 101. For example, the client-side recording application 102 may record the usage data of a user of the computer 101 by repeatedly invoking the print screen function, then saving each image, or may record specific websites accessed, alphanumeric characters entered, text/video chat sessions opened, or recognizable events on the computer 101 (collectively or individually referred to herein as usage, usage data, or usage content). The client-side recording application 102 may associate each saved image with any combination of a date/time stamp, user-name, website 107 accessed over the network 10, and/or other criteria. The print screen function may be invoked at a specific time interval (e.g., 1 millisecond, second, minute, hour etc.) or the application 102 may have a default setting associated with recording the user's usage data at a default interval. The images, which may correspond to the graphics shown on the display device of the computer 101, may be saved to memory (e.g., memory 302, local storage 306, FIG. 3) on the computer 101 and maintained there for some period of time or may be transmitted over the network 10 using, for example, network interface card 304, to one or more servers 103 with access to one or more storage devices. The transmission of the saved usage data by the application 102 using the network 10 may be performed continuously or at a specific time interval. In some embodiments, the saved usage data is stored locally in memory until a threshold capacity of the memory is reached. The threshold may be the maximum size of the memory, a default value, or may be configured through the client-side recording application 102. The one or more servers 103 with access to one or more storage devices may receive and record the transmitted usage data, and may associate the transmitted usage data with the client-side recording application 102, user, and/or computer 101 from which the usage data was received. The application 102 may execute as background process in a multi-threaded environment, for example, without the user of the computer 101 being aware of the application's execution. For example, the parent (or any qualified user) of a child user (or any user) may configure the settings of the application 102 such that it starts upon the child (or any user) logging in, at a predetermined start time, or based on other criteria such as a next user session, for a given number of user sessions, during all sessions within a date range, or for all sessions all the time. In some embodiments, immediately upon starting, the client-side recording application 102 may start recording user actions along with user interaction with the user interface.

In some embodiments, the settings of the application 102 may also be configured to stop its execution upon the child (or any user) logging in/out of the computer 101, at a predetermined stop time, after some time has passed since the application's start time, or based on other criteria. The settings associated with the application 102 may be stored locally in the computer 101 in an encrypted file or other file that may not be accessed or altered by any user except a qualified user.

In some embodiments, the access and play application 104 (or, alternatively, recording/playback application) may be implemented by a recording/playback application module 409 (shown in FIG. 4) that executes on an operating system 407 (also shown in FIG. 4). The recording/playback application module 409 (or, a browser module 408 executing an embedded recording/playback application module 404) may call one or more modules via an application programming interface (API), or may implement the programming code (e.g., object-oriented event/exception-based code) necessary, for accessing and playing usage data, of a user of the computer 101, from the one or more servers 103 with access to one or more storage devices. For example, the application 104 may execute on a playback computer 105 (or handheld/mobile device, not shown), which may communicate with the one or more servers 103 over the network 10. The application 104 may send a request to the servers 103 for access to the usage data of the user of the computer 101. The request may be approved following an authorization procedure such as, for example, a login by way of a username or password or other means known to one of ordinary skill in the art. If the request for access is not approved following the authorization procedure, the playback computer 105 executing the access and application 104 is denied access to the usage data of the user of the computer 101. If the request is approved, a network connection may be established between the servers 103 and the playback computer 105 for transmitting the usage data from the one or more server 103 to the computer 105. The access and play application 104 may, upon receipt of the transmitted usage data, play the usage data in a player 106. The usage data played in the player 106 may be text, picture, slideshow, video, or other media format, with or without audio. Although the usage data may be played immediately upon receipt, the player 106 may utilize memory (e.g., memory 302, local storage 306) to buffer the usage data as it is received. The size of the buffer available for the player 106 may be configured using the settings of the access and play application 104. In some embodiments, the usage data received may be saved to memory first, prior to the user of the playback computer 105 invoking the play feature of the player 106.

FIG. 2 is an illustration of an exemplary embodiment 200 in accordance with the present invention where usage data may be recorded client-side and accessed directly without the use of a network. The client-side recording application 202 operates like the client-side recording application 102 except that it may not interface with any servers (e.g., servers 103) over network 10. Rather, the usage data that is recorded may be saved locally in memory (e.g., memory 302, local storage 306), and not in the storage devices accessible by any servers. In addition, the access and play applications 204, 208, whether executed on the playback computer 205 or the user computer 201, operate similar to the access and play application 104 except that they may not request usage data from any servers, or receive any such usage data from any servers. Rather, if the qualified user of the access and play application 204, 208 is authorized (e.g., successful login), the usage data (e.g., interactions with hosted website(s) 207) may be received from the memory of the user's computer 201 and played in the player 206 (also available to the access and play application 208). 100471 In some embodiments, as shown, the access and play application 208 and the client-side recording application 202 may be implemented as separate applications or as features of a single recording/playback application, without departing from the scope of the present invention.

In some embodiments, the playback computer 205 may connect directly with the user's computer 201 using a wired (e.g., USB, serial/parallel port) or wireless (e.g., Bluetooth) connection. The access and play application 204 may request access to the usage data saved in memory on the user's computers 201 as a client of the access and play application 208, which may be executing on the user's computers 201.

FIG. 3 is an illustration of an exemplary system block diagram 300 of a computer or mobile device executing the parent recording/playback application in accordance with the present invention. The exemplary system 300 for implementing an exemplary embodiment of the present invention comprises a computer processing unit (CPU) 301, memory 302, display device(s) 303, a network interface card (NIC) 304, auxiliary device(s)/component(s) 305, and local storage 306. These elements may communicate over one or more local buses. The CPU 301 may fetch instructions to execute from memory 302, where the instructions may be from an operating system 307 and, further, from a browser 308 (with or without having an embedded recording/playback application) and/or recording/playback application 309 (with or without being embedded in a browser) executing via the operating system 307. The recording/playback application 309 may receive/fetch files from local storage 306 and/or over a network 10 using the NIC 304 for communication with one or more servers 103. The recording/playback application 309 may also be embedded within a browser 308 and may access files in local storage 306 and/or over a network 10. The display device(s) 303 may be a laptop or computer display, TV screen, or other display (e.g., such as that of a handheld device) capable of receiving display signals. The display signals may comprise, for example, one or more frames per second of video or other content. The content may be opened and played by the recording/playback application 309. Other auxiliary device(s)/component(s) 305 may also receive or otherwise communicate via the local bus. For example, a portable media player, mobile telephone, or other auxiliary device may act as a source/sink of files. The auxiliary device(s)/component(s) 305 may also be additional display devices and/or devices capable of supporting the execution of the recording/playback application 309.

FIG. 4 is an illustration of an exemplary application modules diagram 400 of the execution of the modules/engines of a recording/playback application 409 in accordance with the present invention. The exemplary modules 400 for implementing an exemplary embodiment of the present invention comprise browser modules 401-404 and/or recording/playback application 410-412. The browser modules 401-404 may comprise a communications module 401, an interpreter 402 (e.g., XML, HTML or script/mark-up language interpreter), browser components 403 (e.g., navigation functions, add-in(s)/on(s), custom user options), and an embedded recording/playback application 404. The recording/playback application modules 410-412 may comprise feature components 410, a content reader 411, and a controller 412. The browser modules 401-404 may be used to implement the browser-related features of the exemplary embodiments, while the recording/playback application modules 410-412 may be used to implement the recording/playback application-related features of the exemplary embodiments.

In some embodiments, the communications module 401 receives and transmits data over a network (e.g., network 10) through one or more ports (e.g., HTTP port 80); the interpreter 402 may interpret scripts/mark-up languages and execute them in accordance with their instructions; the browser components 403 may implement features such as those for navigating the Internet, supporting add-in(s)/on(s), implementing custom user options and executing in accordance with those options (e.g., permissions, home page preference, bookmarks, script preferences, history preferences, privacy preferences, web page preferences, and/or other Internet/user options); and, the embedded recording/playback application 404 (which may, in some embodiments, be an add-in/on) may record, transmit, and play usage content in accordance with the present invention as described herein.

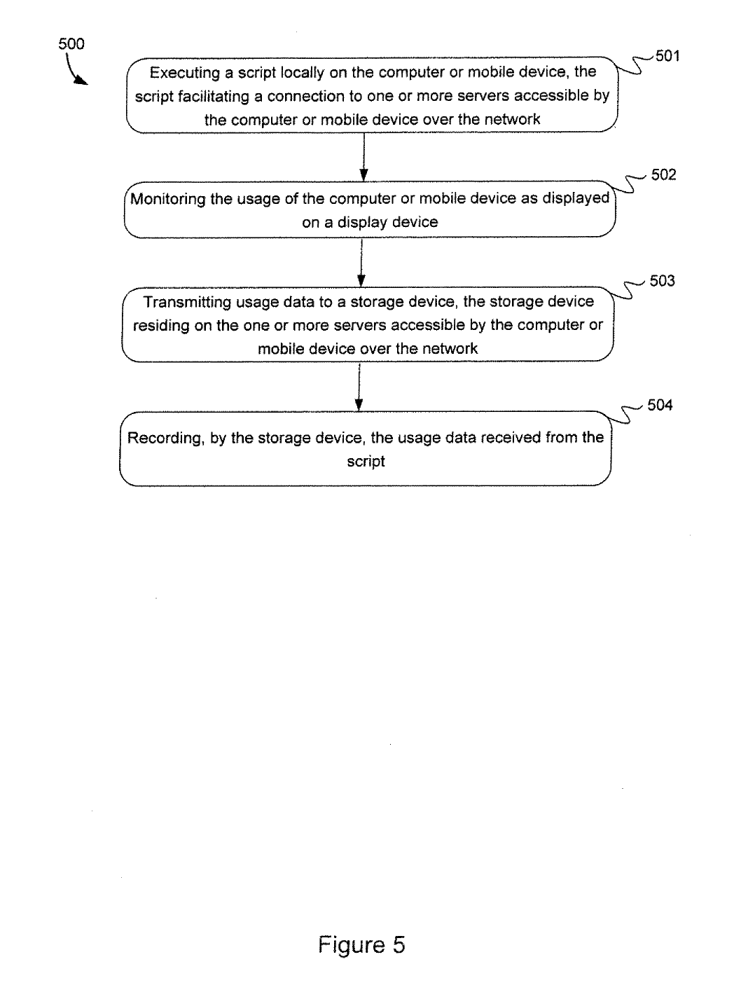

FIG. 5 is an illustration of exemplary method steps 500 for monitoring, transmitting, and recording usage of a computer or mobile device connected to a network. The computer-implemented methods steps are for executing a script locally on the computer or mobile device, the script facilitating a connection to one or more servers accessible by the computer or mobile device over the network 501; monitoring the usage of the computer or mobile device as displayed on a display device 502; transmitting usage data to a storage device, the storage device residing on the one or more servers accessible by the computer or mobile device over the network 503; and recording, by the storage device, the usage data received from the script 504.

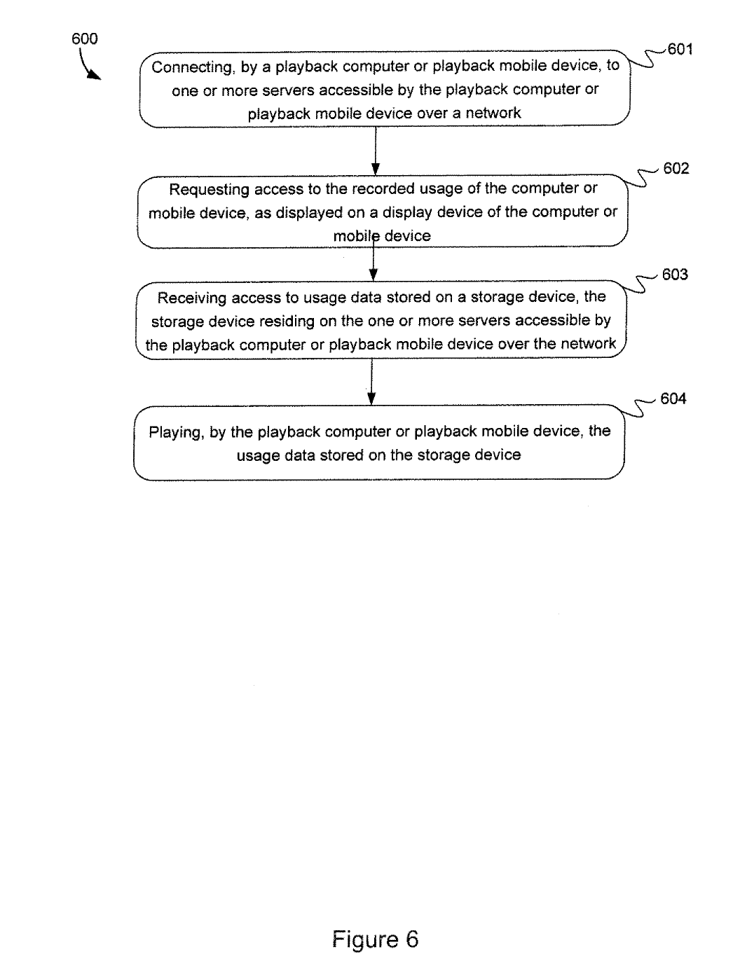

FIG. 6 is an illustration of exemplary method steps 600 for playing recorded usage of a computer or mobile device. The computer-implemented methods steps are for connecting, by a playback computer or playback mobile device, to one or more servers accessible by the playback computer or playback mobile device over a network 601; requesting access to the recorded usage of the computer or mobile device, as displayed on a display device of the computer or mobile device 602; receiving access to usage data stored on a storage device, the storage device residing on the one or more servers accessible by the playback computer or playback mobile device over the network 603; and playing, by the playback computer or playback mobile device, the usage data stored on the storage device 604.

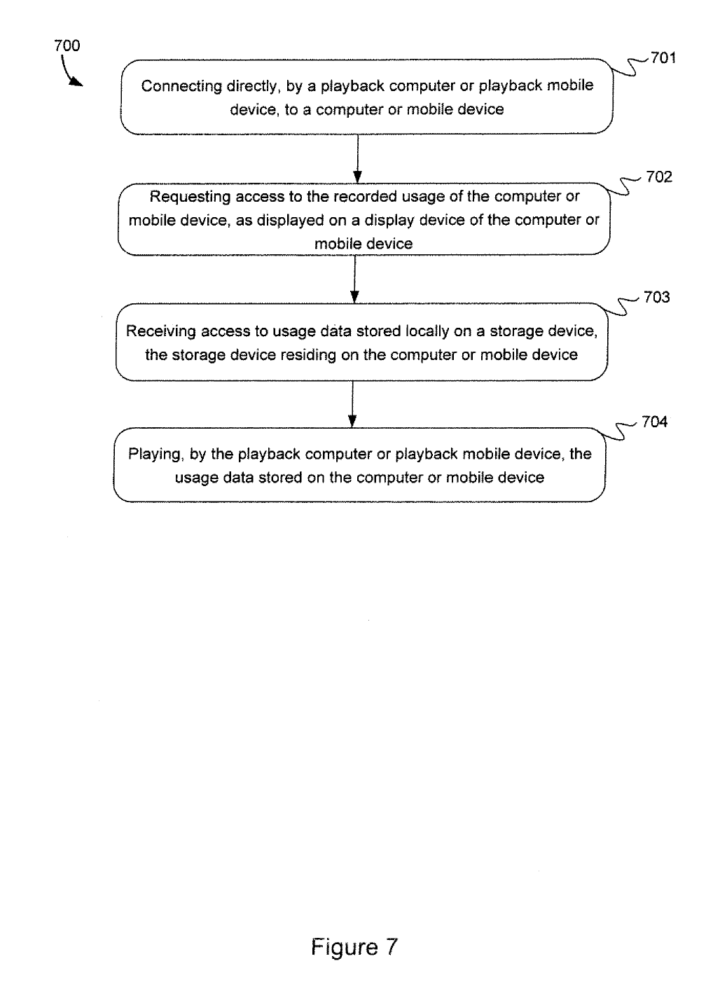

FIG. 7 is an illustration of exemplary method steps 700 for playing recorded usage of a computer or mobile device without connecting to a network. The computer-implemented methods steps are for connecting directly, by a playback computer or playback mobile device, to a computer or mobile device 701; requesting access to the recorded usage of the computer or mobile device, as displayed on a display device of the computer or mobile device 702; receiving access to usage data stored locally on a storage device, the storage device residing on the computer or mobile device 703; and playing, by the playback computer or playback mobile device, the usage data stored on the computer or mobile device 704.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

We claim:

1. A computer-implemented method for monitoring, transmitting, and recording usage of a computer or mobile device connected to a network, comprising the steps of:
executing a script locally on the computer or mobile device, the script facilitating a connection to one or more servers accessible by the computer or mobile device over the network;
monitoring the usage of the computer or mobile device as displayed on a display device;
transmitting usage data to a storage device, the storage device residing on the one or more servers accessible by the computer or mobile device over the network; and
recording, by the storage device, the usage data received from the script.

2. The computer-implemented method of claim 1, wherein the monitoring step further comprises invoking a print screen function.

3. The computer-implemented method of claim 2, wherein the print screen function is invoked at a specific time interval.

4. The computer-implemented method of claim 1, wherein the monitoring step further comprises saving temporarily the usage in local memory on the computer or mobile device.

5. The computer-implemented method of claim 1, wherein the transmitting step is performed continuously.

6. The computer-implemented method of claim 4, wherein the transmitting step is performed when the local memory available for saving temporarily is near a threshold capacity.

7. The computer-implemented method of claim 1, wherein the executing step is performed at a predetermined start time.

8. The computer-implemented method of claim 1, further comprising the step of stopping the execution of the script at a predetermined stop time.

9. The computer-implemented method of claim 1, further comprising the step of stopping the execution of the script after a predetermined time has passed.

10. The computer-implemented method of claim 1, further comprising the step of accessing the usage data recorded on the storage device.

11. A system for monitoring, transmitting, and recording usage of a computer or mobile device connected to a network, comprising:
one or more processors;
memory;
the one or more processors executing one or more programs stored in the memory, the programs causing the processor to execute one or more instructions to:
execute a script locally on the computer or mobile device, the script facilitating a connection to one or more servers accessible by the computer or mobile device over the network;
monitor the usage of the computer or mobile device as displayed on a display device;
transmit usage data to a storage device, the storage device residing on the one or more servers accessible by the computer or mobile device over the network; and
record, by the storage device, the usage data received from the script.

12. The system of claim 11, wherein the monitor instruction further comprises invoking a print screen function.

13. The system of claim 12, wherein the print screen function is invoked at a specific time interval.

14. The system of claim 11, wherein the monitor instruction further comprises saving temporarily the usage in local memory on the computer or mobile device.

15. The system of claim 11, wherein the transmit instruction is performed continuously.

16. The system of claim 14, wherein the transmit instruction is performed when the local memory available for saving temporarily is near a threshold capacity.

17. The system of claim 11, wherein the execute instruction is performed at a predetermined start time.

18. The system of claim 11, further comprising an instruction to stop the execution of the script at a predetermined stop time.

19. The system of claim 11, further comprising an instruction to stop the execution of the script after a predetermined time has passed.

20. The system of claim 11, further comprising an instruction to access the usage data recorded on the storage device.

21. A computer-readable storage medium, storing one or more programs configured for execution, the one or more programs for monitoring, transmitting, and recording usage of a computer or mobile device connected to a network, the one or more programs comprising instructions to:
execute a script locally on the computer or mobile device, the script facilitating a connection to one or more servers accessible by the computer or mobile device over the network;
monitor the usage of the computer or mobile device as displayed on a display device;
transmit usage data to a storage device, the storage device residing on the one or more servers accessible by the computer or mobile device over the network; and
record, by the storage device, the usage data received from the script.

22. A computer-implemented method for playing recorded usage of a computer or mobile device, comprising the steps of
connecting, by a playback computer or playback mobile device, to one or more servers accessible by the playback computer or playback mobile device over a network;
requesting access to the recorded usage of the computer or mobile device, as displayed on a display device of the computer or mobile device;
receiving access to usage data stored on a storage device, the storage device residing on the one or more servers accessible by the playback computer or playback mobile device over the network; and
playing, by the playback computer or playback mobile device, the usage data stored on the storage device.

23. A computer-implemented method for playing recorded usage of a computer or mobile device without connecting to a network, comprising the steps of:
connecting directly, by a playback computer or playback mobile device, to a computer or mobile device;
requesting access to the recorded usage of the computer or mobile device, as displayed on a display device of the computer or mobile device;
receiving access to usage data stored locally on a storage device, the storage device residing on the computer or mobile device; and
playing, by the playback computer or playback mobile device, the usage data stored on the computer or mobile device.
